(19) United States
(12) Patent Application Publication
(10) Pub. No.: US 2015/0186201 A1
(43) Pub. Date: Jul. 2, 2015

(54) ROBUST LINK TRAINING PROTOCOL

(71) Applicant: Intel Corporation, Santa Clara, CA (US)

(72) Inventor: Adee O. Ran, Maayan Baruch (IL)

(21) Appl. No.: 14/520,884

(22) Filed: Oct. 22, 2014

Related U.S. Application Data
(60) Provisional application No. 61/923,108, filed on Jan. 2, 2014.

(51) Int. Cl. G06F 11/07; G06F 11/20; G06N 99/00

(52) U.S. Cl. CPC G06F 11/0757; G06N 99/005; G06F 11/2007

(57) ABSTRACT

Methods, apparatus and systems implementing robust link training processes and protocols. A first timer is implemented in a training state machine to detect timely responses to incoming requests when frame_lock is TRUE. A second timer is implemented to ensure the initial acquisition and re-acquisition of frame_lock occur within reasonable times. Additionally, no changes of coefficient field values in outgoing requests may occur when frame_lock is FALSE. Through use of the timers, the maximum times to acquire and re-acquire frame_lock are specified in combination with compliant escape paths that are added to the training state diagram. Under the time requirements, re-acquisition is fast, to prevent starvation of the control channel, while the time requirement for initial acquisition is longer in consideration of other start-up activities that are being performed concurrently.

### CROSS-REFERENCE TO RELATED APPLICATION

This application claims priority to U.S. Provisional Application Ser. No. 61/923,108, entitled ROBUST LINK TRAINING PROTOCOL TIMING, filed Jan. 2, 2014, under U.S.C. 35 §119.

### BACKGROUND INFORMATION

Ever since the introduction of the microprocessor, computer systems have been getting faster and faster. In approximate accordance with Moore's law (based on Intel® Corporation co-founder Gordon Moore's 1965 publication predicting the number of transistors on integrated circuits to double every two years), the speed increase has shot upward at a fairly even rate for nearly three decades. At the same time, the size of both memory and non-volatile storage has also steadily increased, such that many of today's personal computers are more powerful than supercomputers from just 10-15 years ago. In addition, the speed of network communications has likewise seen astronomical increases.

Increases in processor speeds, memory, storage, and network bandwidth technologies have resulted in the build-out and deployment of networks with ever substantial capacities. More recently, the introduction of cloud-based services, such as those provided by Amazon (e.g., Amazon Elastic Compute Cloud (EC2) and Simple Storage Service (S3)) and Microsoft (e.g., Azure and Office 365) has resulted in additional network build-out for public network infrastructure, in addition to the deployment of massive data centers to support these services which employ private network infrastructure.

A typical data center deployment includes a large number of server racks, each housing multiple rack-mounted servers or blade servers. Communications between the rack-mounted servers is typically facilitated using the Ethernet (IEEE 802.3) protocol over copper wire cables. In addition to the option of using wire cables, blade servers and network switches and routers may be configured to support communication between blades or cards in a rack over an electrical backplane or mid-plane interconnect.

In recent years, the speed of Ethernet connections over copper wiring has reached the 10 Gigabits per second (Gb/s) and 40 Gb/s level. Moreover, The IEEE (Institute of Electrical and Electronics Engineers) has recently approved a specification (IEEE 802.3bj) defining a new backplane PHY (Physical Layer) type called 100GBASE-KR4 that is targeted for a bandwidth of 100 Gb/s over electrical backplanes with a loss up to 35 dB at 12.9 GHz. A similar specification for a new 100 Gb/s over a cable connection called 100GBASE-CR4 is also being defined by the IEEE, as well as other 100 Gb/s or higher standards.

In addition to high-speed interconnects associated with Ethernet connections, high-speed interconnect may exist in other forms. For example, one form of high-speed interconnect InfiniBand, whose architecture and protocol is specified via various standards developed by the InfiniBand Trade Association. Another example of a high-speed interconnect is Peripheral Component Interconnect Express (PCI Express or PCIe). The current standardized specification for PCIe Express is PCI Express 3.0, which is alternatively referred to as PCIe Gen 3. In addition, both PCI Express 3.1 and PCI Express 4.0 specification are being defined, but have yet to be approved by the PCI-SIG (Special Interest Group).

An important aspect of high speed link and interconnect operation is link training. During link training, a training signal pattern is transmitted from a transmit port at a first end of the link (i.e., first endpoint) to a receive port at the other (second) link endpoint. The training pattern, among other features, facilitates tuning (e.g., timing adjustments, voltage signal levels) of the link transmitter/receiver pair to account for signal noise and the like, which may lead to data errors. In a similar manner and typically concurrently, link training is also performed between a transmitter at the second link endpoint and a receiver at the first endpoint. For some high speed links, the link or interconnect comprises multiple lanes in each direction, and the training pattern is transmitted over each lane.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating the structure of a 100GBASE-KR4 link, according to one embodiment;

FIG. 2a shows a Physical Media Dependent (PMD) sub-layer link block diagram for a 100GBASE-CR4 link in one direction;

FIG. 2b shows a PMD sub-layer link block diagram for a 100GBASE-KR4 or 100GBASE-KP4 link in one direction;

FIG. 3a is a diagram illustrating mapping for PAM2 encoding;

FIG. 3b is a diagram illustrating mapping for PAM4 encoding;

FIGS. 4a and 4b are diagrams depicting the structure of a training frame, according to one embodiment;

FIG. 5 is a table illustrating an exemplary set of fields used for the Coefficient Update portion of the training frame of FIGS. 4a and 4b;

FIG. 6 is a table illustrating an exemplary set of fields used for the Status Report portion of the training frame of FIGS. 4a and 4b;

FIG. 7 is a training state diagram illustrating training states and logic for implementing link training, according to one embodiment;

FIG. 8a is a combination message flow and training state diagram illustrating use of a frame lock timer;

FIG. 8b is a diagram illustrating selected portions of the training state diagram of FIG. 7 in connection with implementing a frame lock recover state;

FIG. 8c is a combination message flow and training state diagram illustrating a training state sequence under which states are transitioned within specified timing limits;

FIG. 9a is a frontal isometric view of an exemplary blade server chassis in which a plurality of server blades are installed;

FIG. 9b is a rear isometric view of the blade server chassis of FIG. 9a;

FIG. 9c is an isometric frontal view of an exemplary blade server rack in which a plurality of rack-mounted blade server chassis corresponding to FIGS. 9a and 9b are installed;

FIG. 10 shows details of the components of a typical server blade, according to one embodiment; and

FIG. 11 is a schematic diagram illustrating an architecture for a network node employing a network chip configured to implement a robust link training process in accordance with the embodiments disclosed herein.

### DETAILED DESCRIPTION

Embodiments of methods, apparatus and systems implementing a robust link training process and protocol for high-speed links and interconnects are described herein. In the following description, numerous specific details are set forth (such as embodiments pertaining to IEEE 802.3 100 Gb/s links) to provide a thorough understanding of embodiments disclosed and illustrated herein. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

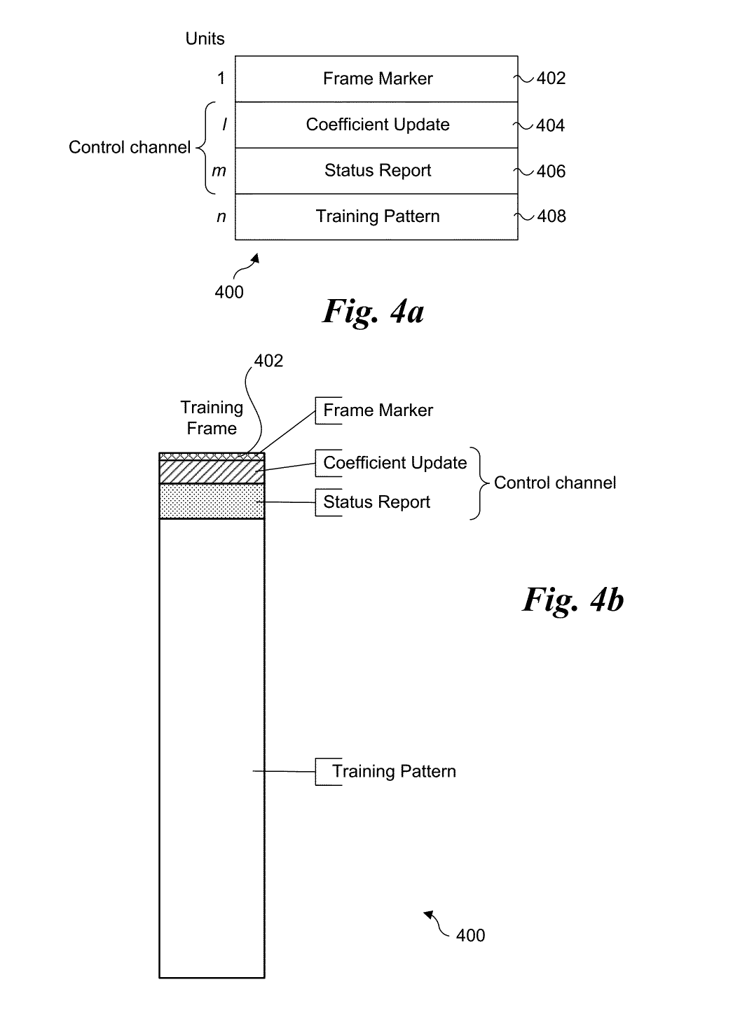

The Ethernet standards for 10 Gb/s and above over backplane and copper cables include a PMD (Physical Media Dependent) control function that enables adjusting the transmitter equalization settings as part of the link training. The PMD control function uses a handshake-based protocol for requesting coefficient changes. The protocol is described by state diagrams (e.g., FIGS. 72-4, 72-5 and 72-6 in IEEE Std 802.3-2012). These figures are referenced in approved and draft standards for multiple PMDs (e.g., 10GBASE-KR, 40GBASE-KR4, 40GBASE-CR4, and 100GBASE-CR10).

The training protocol includes a global timeout, but does not have any limitation on request and response times. As a result, a compliant part may respond with large delays, possibly depriving its link partner from using the PMD control function.

The IEEE P802.3bj Task Force (100 Gb/s Ethernet over backplane and copper cable, recently approved as IEEE 802.3bj-2014), attempted to solve the problem by adding a new requirement for response times in the PMD control function: “after responding to the first request after training begins, the period from receiving a new request to responding to that request shall be less than 2 ms”. However, this is an incomplete solution, as it does not address the time required to answer the first request. Also, it does not define a compliant behavior if the required response time can't be met, and can create a deadlock situation.

In accordance with aspects of the embodiments now described, a solution to the problem is provided that does not have the foregoing deficiencies. Under one aspect, the requirement to have a short response time is conditional on frame_lock (an existing status variable), while timeouts are specified for initial acquisition and reacquisition of frame_lock. In response to a timeout, the protocol goes into a failure state (such as is the case of a global timeout). In addition, to prevent deadlock, a new requirement is added that effectively prevents initiating change requests when frame_lock is not acquired.

By way of example and without limitation, some embodiments are presented herein pertaining to proposed 100 Gb/s Ethernet links, such as the proposed 100GBASE-KR4, 100GBASE-CR4, and 100GBASE-KP4 links. In addition to aspects of these links described herein, other aspects of some embodiments are described in further detail in IEEE P802.3bj-2014, as well as other IEEE 802.3 specifications. This is not meant to be limiting, as similar techniques may be implemented in other high-speed links and interconnects.

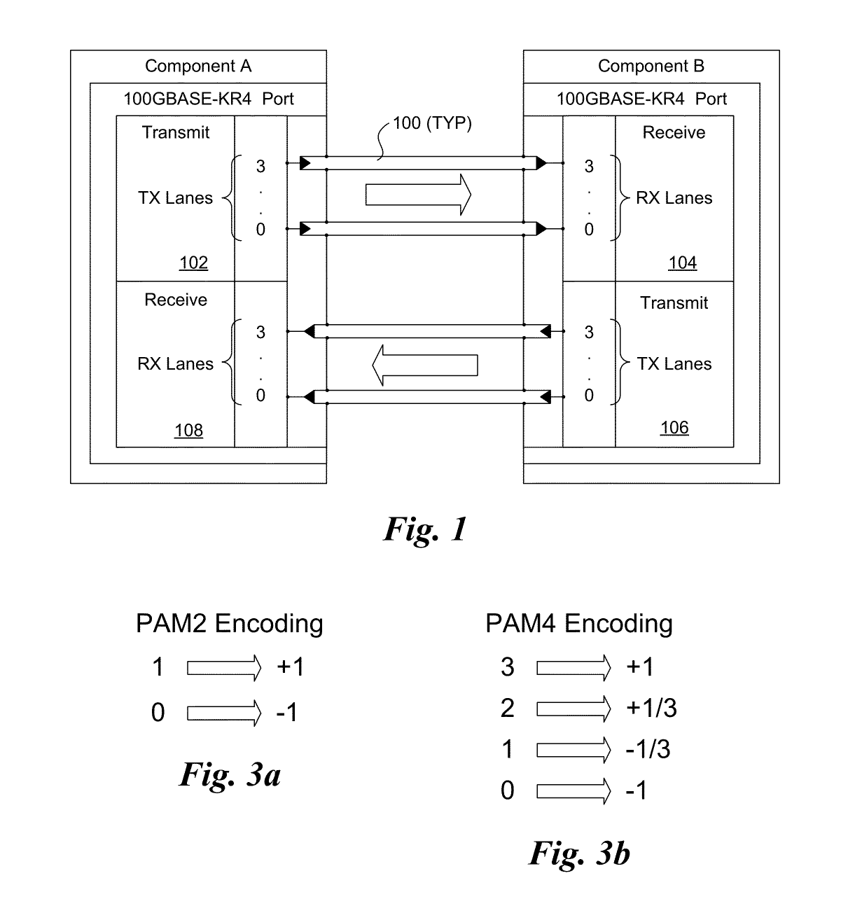

The PHY structure of one embodiment of a 100GBASE-KR4 link is illustrated in FIG. 1. The PHY defines the physical structure of the interconnect and is responsible for dealing with details of operation of the signals on a particular link between two link partners (also referred to as endpoints), such as depicted by components A and B. This layer manages data transfer on the signal wires, including electrical levels, timing aspects, and logical issues involved in sending and receiving each bit of information across the parallel lanes. As shown in FIG. 1, the physical connectivity of each interconnect link is made up of four differential pairs of signals 100, comprising lanes 0-3 in each direction. Each port supports a link pair consisting of two uni-directional links to complete the connection between two components. This supports traffic in both directions simultaneously. The PHY structure of a 100GBASE-CR4 link has a similar configuration to that shown in FIG. 1, as does the PHY structure of a 100GBASE-KP4 link.

Components with 100GBASE-KR4/CR4/KP4 ports communicate using a pair of uni-directional point-to-point links, defined as a link pair, as shown in FIG. 1. Each port comprises a Transmit (Tx) link interface and a Receive (Rx) link interface. For the illustrated example, Component A has a Tx port 102 that is connected to Component B Rx port 104. Meanwhile, Component B has a Tx port 104 that is connected to Component B Rx port 108. One uni-directional link transmits from Component A to Component B, and the other link transmits from Component B to Component A. The “transmit” link and “receive” link is defined relative to which component port is transmitting and which is receiving data. In the configuration illustrated in FIG. 1, the Component A transmit link transmits data from the Component A Tx port 102 to the Component B Rx port 104. This same Component A transmit link is the Port B receive link.

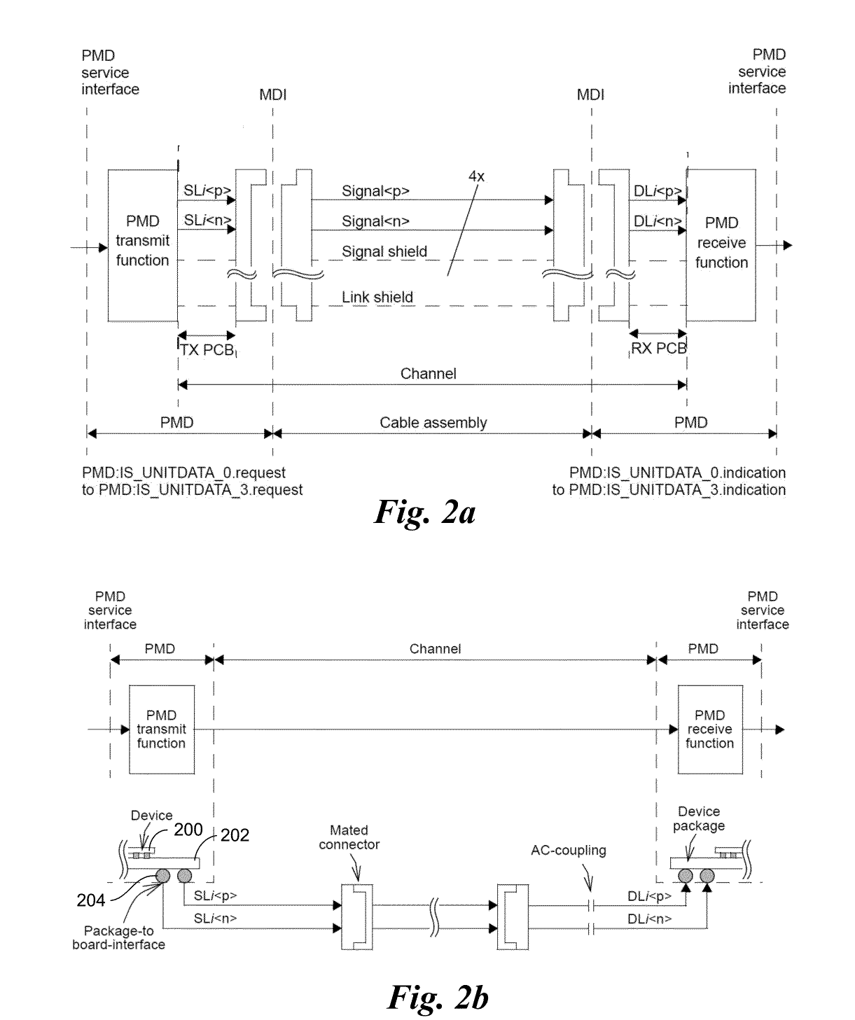

FIG. 2a depicts a Physical Media Dependent (PMD) sub-layer link block diagram for a 100GBASE-CR4 link in one direction. A similar PMD sub-layer link block diagram for a 100GBASE-KR4 link in one direction is shown in FIG. 2b. Each of 100GBASE-CR4 and 100GBASE-KR4 employ four lanes in each direction, with the signaling for each lane implemented using a differential signal pair.

The PMD service interface primitives are summarized as follows:

PMD:IS_UNITDATA_i.request

PMD:IS_UNITDATA_i.indication

PMD:IS_SIGNAL.indication

By way of example, the 100GBASE-CR4 PMD has four parallel bit streams, hence i=0 to 3. The PMA (or the PMD) continuously sends four parallel bit streams to the PMD (or the PMA), one per lane, each at a nominal signaling rate of 25.78125 GBd.

A primary difference between 100GBASE-CR4 and 100GBASE-KR4 is that 100GBASE-CR4 defines use of a cable-based link while 100GBASE-KR4 defines implementation of a link in a circuit board or the like (e.g., in a backplane or mid-plane). Similarly, 100GBASE-KP4 also defines implementation of a link in a circuit board or the like. As depicted in FIG. 2b, a device 200, such as a network interface controller (NIC) chip with a 100GBASE-KR4 PHY, is coupled to a package 202, which in turn is coupled to a board via solder pads 204. Signal paths are routed in the board on separate layers to facilitate transfer of signals between TX and RX ports on the NIC chip or other Ethernet PHY interface ports.

Each of 100GBASE-KR4 and 100GBASE-CR4 use a two-level pulse amplitude modulation (referred to as PAM2) signal to send and receive data across the channel. As shown in FIG. 3a, PAM2 consists of two logical levels that are mapped as follows:

0 maps to −1

1 maps to +1

Logical levels 0 and 1 respectively correspond to low and high level signals having signal levels −1 and +1.

The 100GBASE-KP4 PHY uses a four-level pulse amplitude modulation (referred to as PAM4) signal to send and receive data across the channel. As shown in FIG. 3b, PAM4 consists of four logical levels that are mapped as follows:

| | |
|---|---|
| 0 | maps to −1 |
| 1 | maps to −1/3 |
| 2 | maps to +1/3 |
| 3 | maps to +1 |

Logical levels 0 and 3 respectively correspond to low and high level signals having signal levels −1 and +1, while logical levels 1 and 2 correspond to intermediate level signals have signal levels −⅓ and +⅓.

Under the IEEE P802.3bj-2014 standard, each of the 100GBASE-KR4/CR4/KP4 links is generally established using the following sequence:

(1) Auto-negotiate capabilities to link partner

(2) Send out training sequence to tune PHY for the channel's characteristics
Obtain Frame Lock
TX FFE handshake: Adapt Tx coefficients to channel characteristics
DSP converged: Train Rx to channel
Status Exchange: Ready or not?

(3) Countdown to data mode and Send out idle symbols

The training frame is a fixed length structure that is sent continuously during training. As shown in FIGS. 4a and 4b in one embodiment, a training frame 400 includes a Frame Marker 402, a Control Channel including a Coefficient Update 404 and a Status Report 406, and a Training Pattern 408. Each portion of the training frame as a length of one or more units, wherein a unit has a predefined length such as an octet or word. As depicted by the italicized letters l, m, and n, each of the Coefficient Update 404, a Status Report 406, and a Training Pattern 408 have a length comprising an integer multiple of units. For example, in some embodiments l=4, m=4 or 5, and n varies depending on the particular PMD. Generally, the length of the training pattern n is much larger than l or m, e.g., >100.

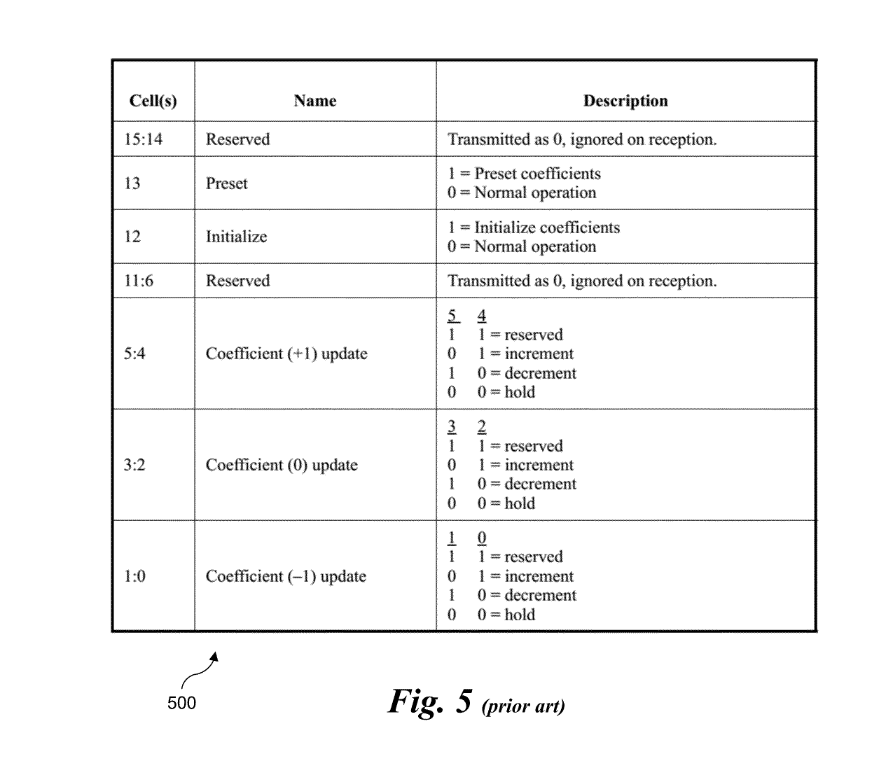

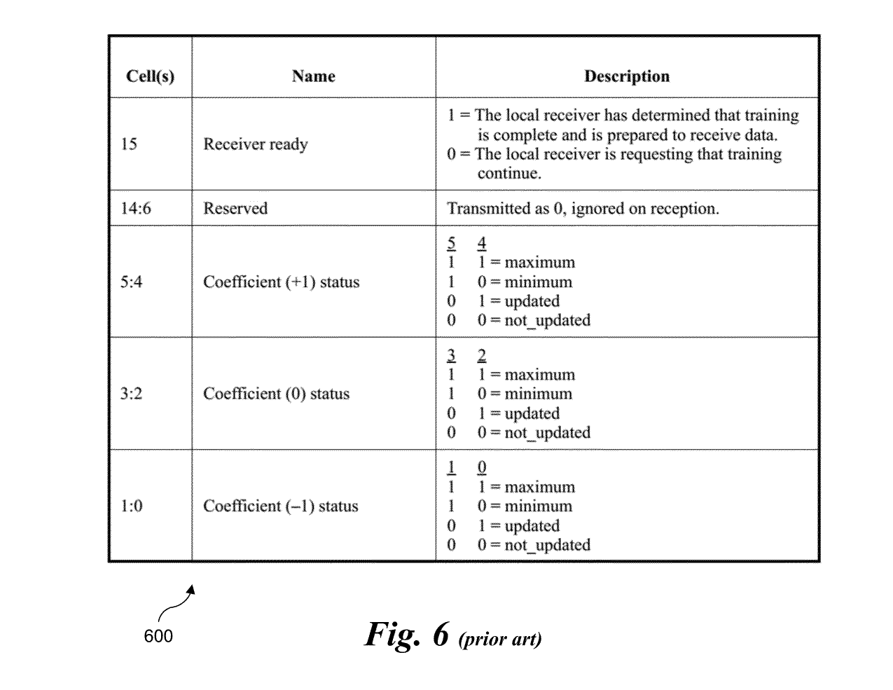

FIGS. 5 and 6 respectively show a Coefficient Update table 500 and Status Report table 600 defined in IEEE 802.3-2012 Clause 72. Each table includes a Cell(s) column, a name column, and a description. The Cell(s) column defines the Cell or Cells occupied by a corresponding coefficient or status value. As described below in further detail, during link training, training frames are exchanged between a pair of link endpoints (referred to as component ‘A’ and component ‘B’, also referred to as link partners). Each training frame includes multiple cells comprising Coefficient Update 404 and Status Report 406 shown in FIGS. 4a and 4b and discussed above. The parameters/values in the Coefficient Update cells are used to convey information relating to setting the coefficients used for tuning the link PHY. The values in the Status Update cells are used to provide status information to the link partner (i.e., the component at the other end of the link), in addition to updating these coefficients.

To facilitate link training, logic in each of the link partners is configured to implement a training state machine having multiple training states. Such training states are typically defined via a training state diagram, such as defined in IEEE 802.3-2012 Clause 72.

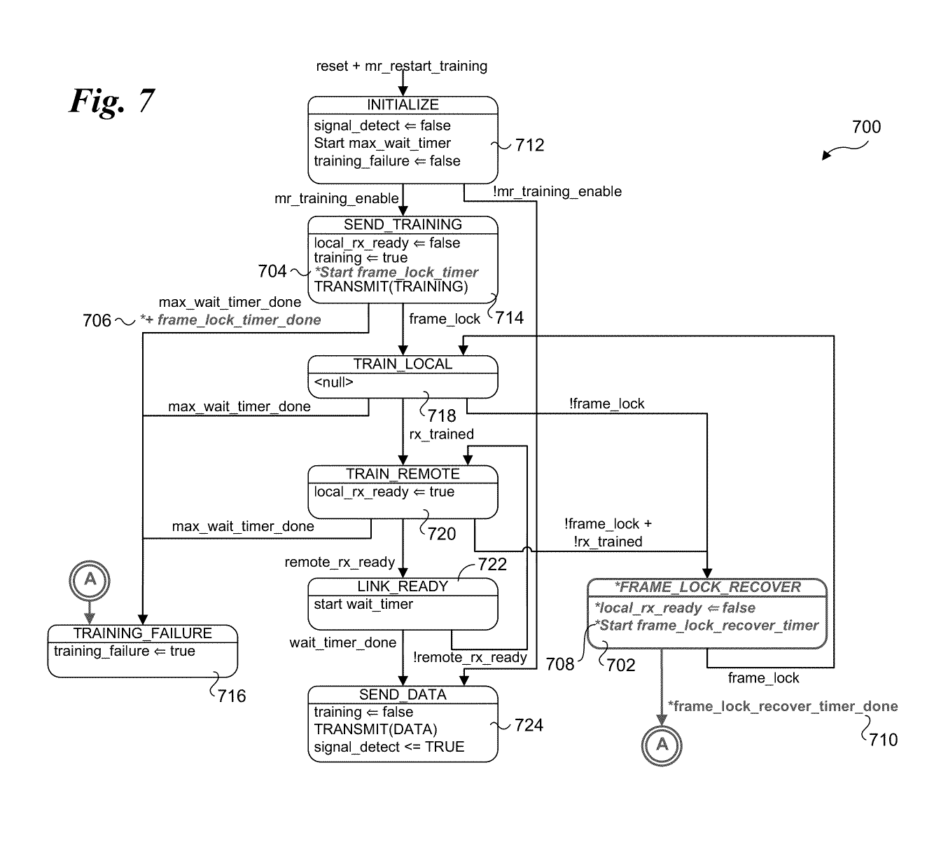

FIG. 7 shows a training state diagram 700 that includes augmentations to the training state diagram defined in the IEEE P802.3bj-2014 standard that add robustness to the link training process, according to one embodiment. In FIG. 7, the content shown in black corresponds to the conventional training state diagram defined in IEEE 802.3-2012 Clause 72, while the blocks and text shown in bolded italicized dark gray and marked with an ‘*’ correspond to the augmented portions of the training state diagram. In addition to new state conditions and statuses discussed below, training state diagram 700 adds a new FRAME_LOCK_RECOVER state 702, as well as two new timers.

As discussed above, the conventional approach defined in the IEEE P802.3bj-2014 standard does not address the time required to answer the first request after training begins, does not define a compliant behavior if the required response time can't be met, and can create a deadlock situation. Under aspects of the embodiments disclosed herein, these deficiencies are addressed in the follow manner using the following considerations.

First, frame_lock is the essential status for the operation of the control channel. (as used herein “frame_lock” refers to a link state or condition under which the status of fame lock is TRUE, and the use of “frame_lock” as a status and “frame lock” as a state or condition may be used interchangeably herein, including in the claims.) Without frame_lock, the receiver cannot decode status messages, so the receiver cannot send new (outgoing) requests. Therefore, there should be no motivation to delay frame_lock.

Under aspects of an embodiment, the following set of requirements are implemented. First, a timely response to incoming requests when frame_lock is TRUE is required. For example, in one embodiment the response is required to be within 2 milliseconds (ms) (e.g., 0-2 ms+/−1%). Second, two new timers are implemented to ensure the initial acquisition and re-acquisition of frame_lock occur within reasonable times. Third, no changes of coefficient field values in outgoing requests may occur when frame_lock is FALSE.

In further detail, the maximum times to acquire and re-acquire frame_lock are specified in combination with compliant escape paths that are added to the training state diagram, as explained below. Under the time requirements, re-acquisition is fast, to prevent starvation of the control channel, while the time requirement for initial acquisition is longer in consideration of other start-up activities that are being performed concurrently. The time requirements are implemented via the two new timers, wherein expiration of a timer leads to a TRAINING_FAILURE state.

Returning to FIG. 7, two new timers are implemented: a frame_lock_timer having an associated operation Start frame_lock_timer 704 and an associated status frame_lock_timer_done 706; and a frame_lock_recover_timer having an associated operation Start frame_lock_recover_timer 708 and an associated status frame_lock_recover_timer_done 710.

In one embodiment, each lane of the PMD interface uses the same control function as 10GBASE-KR, as defined in IEEE 802.3-2012 Clause 72.6.10, with the following modifications. The variables rx_trained_i, frame_lock_i, training_i, and training_failure_i (where i goes from 0 to 3) report status for each lane and are equivalent to rx_trained, frame_lock, training, and training_failure as defined in IEEE 802.3-2012 Clause 72.6.10.3.1. In addition to the requirements in IEEE 802.3-2012 Clause 72.6.10.2.3, when frame_lock_i is FALSE for lane i, the value for the coefficient update field in lane i keeps its value unchanged.

In addition to the coefficient update process specified in IEEE 802.3-2012 Clause 72.6.10.2.5, when frame_lock_i is TRUE for lane i, the period from receiving a new request on lane i to responding to that request shall be less than 2 ms. The start of the period is the frame marker of the training frame with the new request and the end of the period is the frame marker of the training frame with the corresponding response. A new request occurs when the coefficient update field is different from the coefficient field in the preceding frame. The response occurs when the coefficient status report field is updated to indicate that the corresponding action is complete.

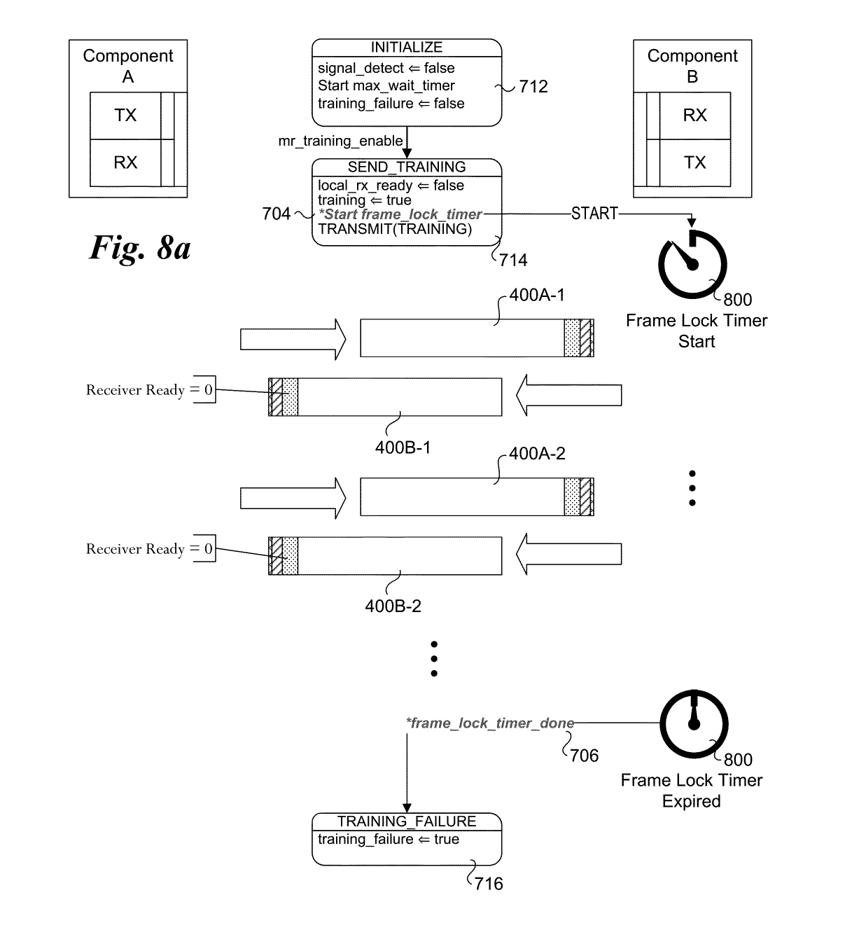

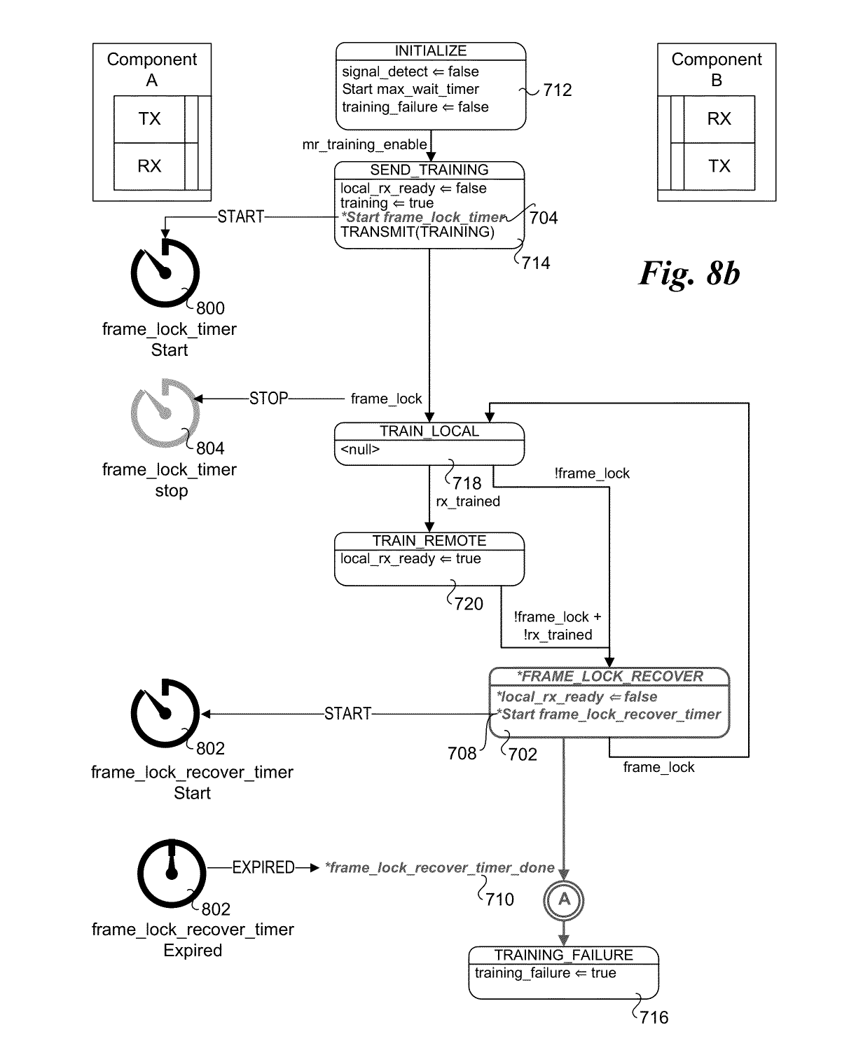

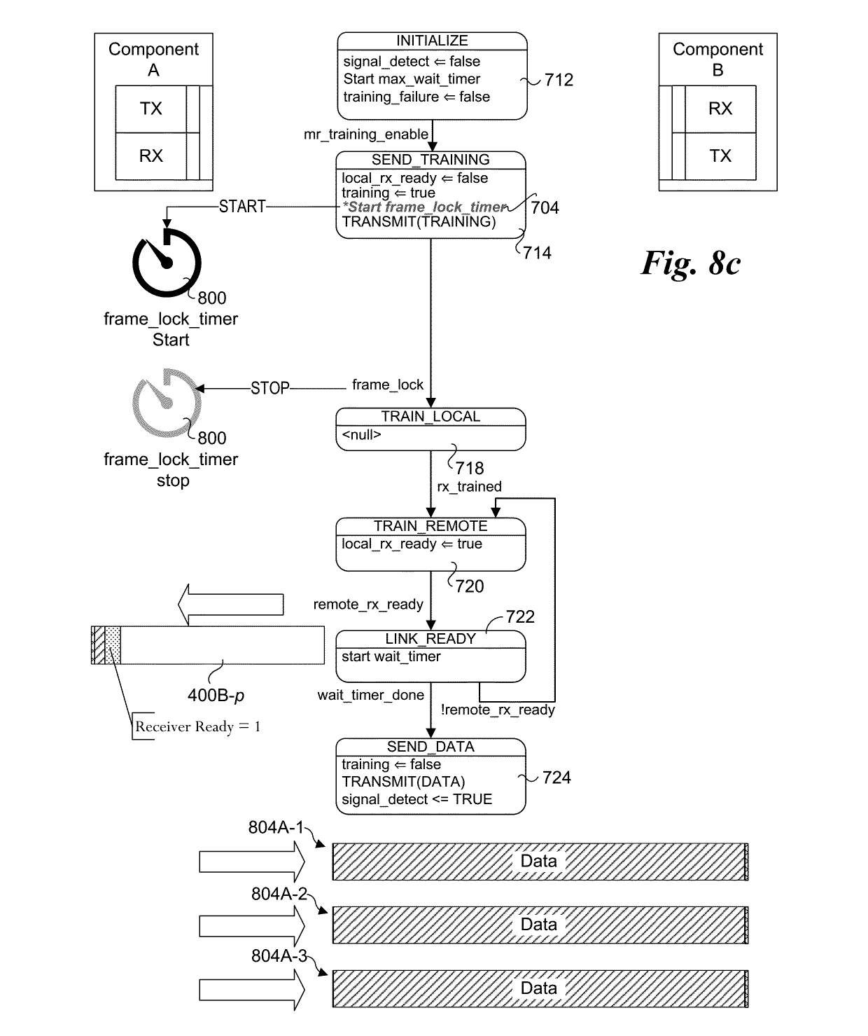

FIGS. 8a-c are combination message flow and training state diagrams illustrating a link training process in accordance with training state diagram 700. These diagrams illustrate operations performed for one lane from the perspective of the component (i.e., link partner) at one end of the link. It will be understood that similar operations are performed for each lane for a given link partner, and each end of the link is concurrently performing similar operations over multiple lanes.

As depicted in FIGS. 7 and 8a, the link training process starts with an INITIALIZE state 712 during which a max_wait_timer is started. Once training is enabled (via mr_training_enable), the state advances to a SEND_TRAINING state 714. In addition to the conventional operations (local_rx_ready [symbol] false, training [symbol] true, and TRANSMIT(TRAINING), a frame lock timer 800 is started (corresponding to Start frame_lock_timer status 704). As further depicted in FIG. 8a, training frames 400A-j are sent from Component A to Component B, while training frames 400B-j are sent from Component B to Component A, wherein j represents a sequence number (which is used for illustrative purposes herein, but does not exist in an actual implementation). During the SEND_TRAINING state the Receiver Ready value in each training frame 400B-j will have a value of ‘0’, indicating the Receiver (of component B for lane i) is not ready, as depicted by training frames 400B-1 and 400B-2.

As depicted in FIG. 7, if the frame_lock_timer expires (frame_lock_time_done status 706) prior to acquiring frame_lock, the training state proceeds to TRAINING_FAILURE state 716. This is also shown in FIG. 8a, where frame_lock_timer 800 has expired before frame_lock is acquired. As shown by the conventional portion of training state diagram 700, a similar result (state becomes TRAINING_FAILURE state 716) if the max_wait_timer expires. In one embodiment, frame_lock_timer 800 expires after 50 ms.

FIG. 8b illustrates a training state sequence that advances to a TRAIN_LOCAL state 718 and a TRAIN_LOCAL state 720. As before, in conjunction with entering SEND_TRAINING state 714, frame_lock_timer 800 is started. However, in this example frame_lock is acquired prior to frame_lock_timer 800 expiring, which causes frame_lock_timer 800 to be disregarded or otherwise ignored. Upon acquiring frame_lock, the state advanced to TRAIN_LOCAL state 718. If while in TRAIN_LOCAL state 718 frame_lock is lost (as depicted by !frame_lock), the state machine logic proceeds to FRAME_LOCK_RECOVER state 702. This sets the local receiver ready (local_rx_ready) parameter to FALSE (noting that this does not result in a change if arriving at FRAME_LOCK_RECOVER state 702 from TRAIN_LOCAL state 718), and starts a frame-lock_recover_timer 802 as depicted by Start frame_lock_recover_timer status 708.

FRAME_LOCK_RECOVER state 702 can also be reached from TRAIN_REMOTE state 720, which follows TRAIN_LOCAL state 718 after the local training is complete, as indicated by an rx_trained status that is TRUE. The rx_trained status of the link partner is sent over the training frame and is available locally as the remote_rx_ready status. If both rx_trained and remote_rx_ready are TRUE and stable, then the remote transmit and local receive equalizers have been optimized on both sides, and normal data transmission may commence; otherwise, it is to FALSE. In this instance, if either frame_lock is lost or rx_trained status becomes FALSE (depicted as !rx_trained), then the state will advance to FRAME_LOCK_RECOVER state 702. Upon entering FRAME_LOCK_RECOVER state 702, local_rx_ready is reset to FALSE.

Once in FRAME_LOCK_RECOVER state 702 there are two possibilities that will result in a state change. If frame_lock is re-acquired before frame_lock_recover_timer 802 expires, then the state will return to TRAIN_LOCAL state 718. Conversely, if frame_lock_recover_timer 802 expires prior to acquiring frame_lock, frame_lock_recover_timer_done status 710 is invoked, resulting in a state change to TRAINING_FAILURE state 716. In one embodiment, frame_lock_recover_timer 802 expires after 2 ms (+/−1%); however, this is merely exemplary, as other timer values may be used.

FIG. 8c depicts a training state sequence corresponding to a normal link initialization. As in FIG. 8b, upon reaching SEND_TRAINING state 714 frame_lock_timer 800 is started and is stopped when frame_lock is acquired. In this instance, frame_lock is not lost while in either TRAIN_LOCAL state 718 or TRAIN_REMOTE state 720, resulting in a remote receiver ready status (remote_rx_ready), which is indicated to component A by a training frame 400B-p in reach the Receiver Ready field value is ‘1’. The link state for lane i then advances to LINK_READY state 722, which starts a wait_timer in the illustrated embodiment. Once the wait_timer is done without losing the remote receiver ready state (depicted as !remote_rx_ready), the state may advance to SEND_DATA state 724. Data frames may then be transmitted between components A and B, as depicted by data frames 804A-1, 804A-2, and 804A-3 sent from component A.

### Exemplary Implementation Environment and Blade Server Architecture

It is envisioned that aspects of the embodiments herein may be implemented in various types of computing and networking equipment, such as switches, routers and blade servers such as those employed in a data center and/or server farm environment. Typically, the servers used in data centers and server farms comprise arrayed server configurations such as rack-based servers or blade servers. These servers are interconnected in communication via various network provisions, such as partitioning sets of servers into LANs with appropriate switching and routing facilities between the LANs to form a private Intranet. For example, cloud hosting facilities may typically employ large data centers with a multitude of servers.

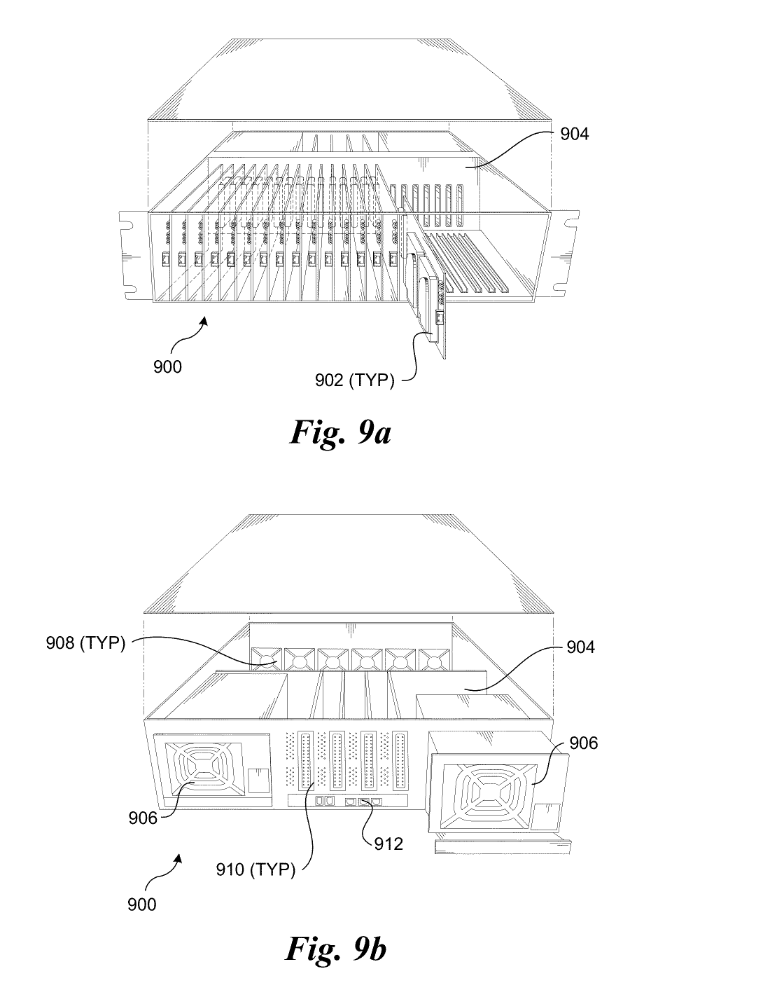

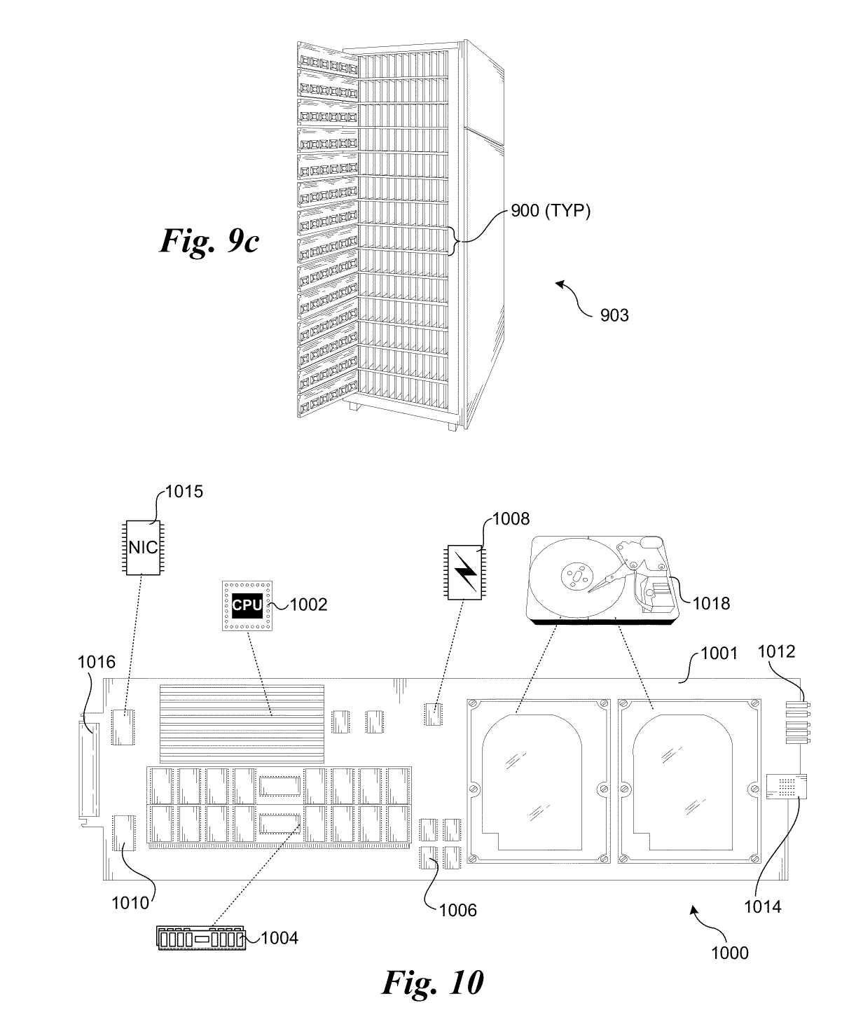

As an overview, typical blade server components and systems are shown in FIGS. 9a-c, and 10. Under a typical configuration, a rack-mounted chassis 900 is employed to provide power and communication functions for a plurality of server blades (i.e., blades) 902, each of which occupies a corresponding slot. (It is noted that all slots in a chassis do not need to be occupied.) In turn, one or more chassis 900 may be installed in a blade server rack 903 shown in FIG. 9c. Each blade is coupled to an interface plane 904 (i.e., a backplane or mid-plane) upon installation via one or more mating connectors. Typically, the interface plane will include a plurality of respective mating connectors that provide power and communication signals to the blades, and including routed signal paths for coupling Ethernet signals between blades. Under current practices, many interface planes provide “hot-swapping” functionality—that is, blades can be added or removed (“hot-swapped”) on the fly, without taking the entire chassis down through appropriate power and data signal buffering.

A typical mid-plane interface plane configuration is shown in FIGS. 9a and 9b. The backside of interface plane 904 is coupled to one or more power supplies 906. Oftentimes, the power supplies are redundant and hot-swappable, being coupled to appropriate power planes and conditioning circuitry to enable continued operation in the event of a power supply failure. In an optional configuration, an array of power supplies may be used to supply power to an entire rack of blades, wherein there is not a one-to-one power supply-to-chassis correspondence. A plurality of cooling fans 908 are employed to draw air through the chassis to cool the server blades.

An important feature required of all blade servers is the ability to communicate externally with other IT infrastructure. This is typically facilitated via one or more network connect cards 910, each of which is coupled to interface plane 904. Generally, a network connect card may include a physical interface comprising a plurality of network port connections (e.g., RJ-45 ports), or may comprise a high-density connector designed to directly connect to a network device, such as a network switch, hub, or router.

Blade servers usually provide some type of management interface for managing operations of the individual blades. This may generally be facilitated by a built-in network or communication channel or channels. For example, one or more buses for facilitating a “private” or “management” network and appropriate switching may be built into the interface plane, or a private network may be implemented through closely-coupled network cabling and a network. Optionally, the switching and other management functionality may be provided by a management switch card 912 that is coupled to the backside or frontside of the interface plane. As yet another option, a management or configuration server may be employed to manage blade activities, wherein communications are handled via standard computer networking infrastructure, for example, Ethernet.

With reference to FIG. 10, further details of an exemplary blade 1300 are shown. As discussed above, each blade comprises a separate computing platform that is configured to perform server-type functions, i.e., is a “server on a card.” Accordingly, each blade includes components common to conventional servers, including a main printed circuit board (main board) 1001 providing internal wiring (i.e., buses) for coupling appropriate integrated circuits (ICs) and other components mounted to the board. These components include one or more processors 1002 coupled to system memory 1004 (e.g., some form of Random Access Memory (RAM)), cache memory 1006 (e.g., SDRAM), and a firmware storage device 1008 (e.g., flash memory). A NIC (network interface controller) chip 1010 is provided for supporting conventional network communication functions, such as to support communication between a blade and external network infrastructure. Other illustrated components include status LED (light-emitting diodes) 1012, a set of RJ-45 console ports 1014 (only one of which is shown for simplicity), and a NIC 1015 coupled to an interface plane connector 1016. Additional components include various passive components (i.e., resistors, capacitors), power conditioning components, and peripheral device connectors.

Generally, each blade 1000 may also provide on-board storage. This is typically facilitated via one or more built-in disk controllers and corresponding connectors to which one or more disk drives 1018 are coupled. For example, typical disk controllers include SATA controllers, SCSI controllers, and the like. A solid state drive (SSD) may be used in place of disk drive 1018. As an option, the disk drives may be housed separate from the blades in the same or a separate rack, such as might be the case when a network-attached storage (NAS) appliance or backend storage sub-system that is employed for storing large volumes of data.

NIC 1010 comprises circuitry and logic for facilitating corresponding networking operations, such as support for physical layer (L1) and data link layer operations (L2). Typically, upper layer operations are facilitated by an operating system network stack that would be hosted by an operating system running on processor 1002. However, in some embodiments, a NIC may employ its own network stack via embedded logic or the like.

In a typical data center deployment, network switching elements comprise rack-mounted equipment, such as would occupy a 1U, 2U, or 4U slot, or may be implemented via one or more server blades. Optionally, a network switching element may be implemented use one or more server blades.

NIC 1015 comprises circuitry and logic for implementing high-speed communication between multiple blades 1000 via interface plane 904. In one embodiment, NIC 1415 is configured to implement signaling and logic corresponding to the 100 Gb/s embodiments disclosed herein, including circuitry and logic for implementing a 100GBASE-KR4/CR4/CP4 port and associated PMD layer operations. To further facilitate inter-blade communication over the 100GBASE-KR4, interface plane 904 includes appropriate connectors, circuitry and wiring for facilitating the physical media aspect of the PHY (wiring not shown). For example, the circuitry may comprise connectors and wiring for facilitating signaling over 8 differential pairs in accordance with the configuration shown in FIG. 1.

In general, aspects of the link training embodiments disclosed herein may be implemented hardware (via, e.g., embedded logic), or via a combination of hardware and software. For example, a network element may include a processor running a software-based network stack and associated logic implemented via software for performing aspects of the operations described herein. Optionally, similar logic could be implemented via embedded logic in a NIC, large-scale network interface, or the like.

In addition to implementation in a blade server, the principles and teachings herein may be implemented via other types of equipment, such as telecommunications routers and switches. For example, a typical telecom switch comprises a rack with multiple cards coupled to a backplane, wherein the cards are generally analogous to the blades and the backplane is analogous to the interface plane in a blade server. Accordingly, the cards would be configured with circuitry and logic for implemented 100GBASE-KR4/CR4/KP4 ports, and the backplane would include connectors, circuitry, and wiring for facilitating the physical media aspect of the 100GBASE-KR4 and 100GBASE-KP4 PHYs.

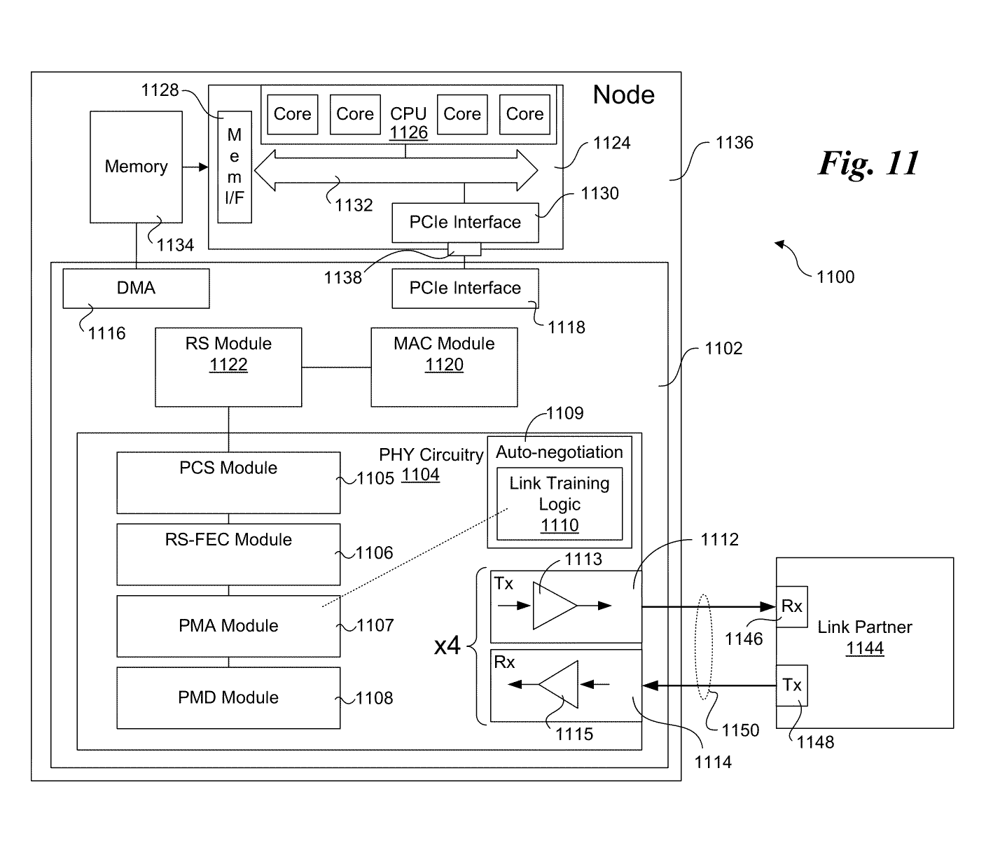

FIG. 11 shows an architecture 1100 for a network node employing a network chip 1102 configured to facilitate link training in accordance with aspects of the embodiments disclosed herein. Network chip 1102 comprises PHY (Physical Layer) circuitry 1104 including a Physical Coding Sublayer (PCS) module 1105, a Reed-Solomon Forward Error Correction (RS-FEC) module 1106, a Physical Medium Attachment (PMA) module 1107, a PMD module 1108, an auto-negotiation module 1109 including link training logic 1110, a transmitter port 1112 including transmitter circuitry 1113 and a receiver port 1114 including receiver circuitry 1115. Network chip 1102 further includes a DMA (Direct Memory Access) interface 1116, a Peripheral Component Interconnect Express (PCIe) interface 1118, a MAC (Media Access Channel) module 1120 and a Reconciliation Sublayer (RS) module 1122. Network node 1100 also comprises a System on a Chip (SoC) 1124 including a Central Processing Unit (CPU) 1126 having one or more processor cores, coupled to a memory interface 1128 and a PCIe interface 1130 via an interconnect 1132. Memory interface 1128 is further depicted as being coupled to memory 1134. Under a typical configuration, network chip 1102, SoC 1124 and memory 1134 will be mounted on or otherwise operatively coupled to a circuit board 1136 that includes wiring traces for coupling these components in communication, as depicted by single lines connecting DMA 1116 to memory 1134 and PCIe interface 1118 to PCIe interface 1130 at a PCIe port 1138.

In one embodiment, MAC module 1120 is configured to implement aspects of the MAC layer operations performed that are well-known in the art. Similar, RS module 1122 is configured to implement reconciliation sub-layer operations.

During link initialization, auto-negotiation module 1109 is implemented for auto-negotiation of link speed and capabilities. The auto-negotiation format consists of a base-page, which is the first set of formatted information exchanged with the link partner, as depicted by a link partner 1144 including a receiver port 1146 and a transmitter port 1148. In one embodiment the configuration of node 1100 and link partner 1144 are similar, and are linked in communication via an Ethernet link 1150.

In one embodiment, network chip 1102 comprises a 100 Gb/s Ethernet Network Interface Controller (NIC) chip employing a 100GBASE-KR4, 100GBASE-CR4, or 100GBASE-KP4 PHY. However, the circuitry and components of network chip 1102 may also be implemented in other types of chips and components, including SoCs, multi-chip modules, and NIC chips including support for multiple network interfaces (e.g., wired and wireless).

In addition, embodiments of the present description may be implemented not only within a semiconductor chip such as a NIC, but also within non-transient machine-readable media. For example, the designs described above may be stored upon and/or embedded within non-transient machine readable media associated with a design tool used for designing semiconductor devices. Examples include a netlist formatted in the VHSIC Hardware Description Language (VHDL) language, Verilog language or SPICE language, or other Hardware Description Language. Some netlist examples include: a behavioral level netlist, a register transfer level (RTL) netlist, a gate level netlist and a transistor level netlist. Machine-readable media also include media having layout information such as a GDS-II file. Furthermore, netlist files or other machine-readable media for semiconductor chip design may be used in a simulation environment to perform the methods of the teachings described above.

In addition to high-speed Ethernet links, aspects of the embodiments disclosed herein may be implemented in other types of high-speed links, such as but not limited to optical links, InfiniBand® links, and PCI Express links. Similarly, the teachings and principles disclosed herein may be applied to both existing and future high-speed links.

Further aspects of the subject matter described herein are set out in the following numbered clauses:

1. A method for training a bi-directional communications link between a pair of link partners at opposing ends of the communications link and including at least one lane, comprising:

for each lane,

implementing a training state machine including multiple training states;

transmitting training frames to a link partner and receiving training frames from the link partner;

detecting frame lock has been acquired;

entering a TRAIN_LOCAL state;

while in the TRAIN_LOCAL state,

detecting whether the frame lock is lost, and if so,

advancing the training state to a FRAME_LOCK_RECOVER state;

while in the FRAME_LOCK_RECOVER state,

starting a frame lock recover timer;

detecting whether the frame lock recover timer has expired prior to re-acquiring frame lock, and if so,

advancing the training state machine state to a TRAINING_FAILURE state.

2. The method of clause 1, further comprising:

detecting frame lock has been re-acquired prior to expiration of the frame lock recover timer; and

returning the training state machine state to the TRAIN_LOCAL state.

3. The method of clause 1 or 2, further comprising:

detecting, while in the TRAIN_LOCAL state, a receiver trained condition, and in response thereto, advancing the training state machine state to a TRAIN_REMOTE state;

while in the TRAIN_REMOTE state,

detecting whether frame lock on received training frames is lost or the receiver trained condition is lost, and if so,

advancing the training state to the FRAME_LOCK_RECOVER state.

4. The method of any of the proceeding clauses, further comprising:

entering a SEND_TRAINING state;

while in the SEND_TRAINING state,

starting a frame lock timer;

detecting whether the frame lock timer has expired prior to acquiring a frame lock on received training frames, and if so,

advancing the training state machine state to the TRAINING_FAILURE state.

5. The method of clause 4, further comprising:

if frame lock is acquired prior to expiration of the frame lock timer,

advancing the training state machine state to the TRAIN_LOCAL state.

6. The method of clause 4, wherein the frame lock timer is configured to expire after 50 milliseconds.

7. The method of any of the proceeding clauses, wherein the frame lock recover timer is configured to expire after 2 milliseconds.

8. The method of any of the proceeding clauses 1, wherein the communication links comprises an Ethernet link.

9. The method of any of the proceeding clauses, wherein the communication link comprises an InfiniBand link.

10. The method of any of the proceeding clauses, wherein each training frame includes a coefficient update field, the method further comprising preventing changes to the coefficient update field when frame lock is not acquired.

11. An apparatus configured to be implemented, when operating, in a first component that is linked in communication with a second component over a bi-directional link, comprising:

Physical Layer (PHY) circuitry, including,

a transmitter port including transmitter circuitry for at least one transmit lane;

a receiver port including receiver circuitry for at least one receive lane; and

link training logic, configured to,

for each receive lane,

implement a training state machine including multiple training states;

transmit training frames to the second component and receive training frames from the second component;

detect frame lock has been acquired on training frames received by the receiver circuitry for the receive lane;

enter a TRAIN_LOCAL state;

while in the TRAIN_LOCAL state,

detect whether the frame lock is lost, and if so,

advance the training state to a FRAME_LOCK_RECOVER state;

while in the FRAME_LOCK_RECOVER state,

start a frame lock recover timer;

detect whether the frame lock recover timer has expired prior to re-acquiring frame lock, and if so,

advance the training state machine state to a TRAINING_FAILURE state.

12. The apparatus of clause 11, wherein the link training logic is further configured to:

detect frame lock has been re-acquired prior to expiration of the frame lock recover timer; and

return the training state machine state to the TRAIN_LOCAL state.

13. The apparatus of clause 11 or 12, wherein the link training logic is further configured to:

detect, while in the TRAIN_LOCAL state, a receiver trained condition, and in response thereto, advancing the training state machine state to a TRAIN_REMOTE state;

while in the TRAIN_REMOTE state,

detect whether frame lock on received training frames is lost or the receiver trained condition is lost, and if so,

advance the training state to the FRAME_LOCK_RECOVER state.

14. The apparatus of any of clauses 11-13, wherein the link training logic is further configured to:

enter a SEND_TRAINING state;

while in the SEND_TRAINING state,

start a frame lock timer;

detect whether the frame lock timer has expired prior to acquiring a frame lock, and if so,

advance the training state machine state to the TRAINING_FAILURE state.

15. The apparatus of clause 14, wherein the link training logic is further configured to:

if frame lock is acquired prior to expiration of the frame lock timer,

advance the training state machine state to the TRAIN_LOCAL state.

16. The apparatus of clause 14, wherein the frame lock timer is configured to expire after 50 milliseconds.

17. The apparatus of any of clauses 11-16, wherein the frame lock recover timer is configured to expire after 2 milliseconds.

18. The apparatus of any of clauses 11-17, wherein the communication links comprises an Ethernet link.

19. The apparatus of any of clauses 11-18, wherein the communication link comprises an InfiniBand link.

20. The apparatus of any of clauses 11-19, wherein each training frame includes a coefficient update field, and the link training logic is further configured to prevent changes to the coefficient update field when frame lock is not acquired.

21. A system comprising:

a chassis;

an inter-plane, mounted within the chassis, having first and second inter-plane connectors and wiring coupled therebetween configured to facilitate a multi-lane Ethernet link;

a first board having a first network interface controller (NIC) including Ethernet transmitter and receiver ports operatively coupled to a first board connector that is coupled to the first inter-plane connector;

a second board having a second NIC including Ethernet transmitter and receiver ports operatively coupled to a second board connector that is coupled to the second inter-plane connector,

wherein the Ethernet transmitter for each of the first and second NICs is configured to transmit data over multiple transmit lanes and the Ethernet receiver is configured to receive data over a receive lane, and the first NIC is configured, when the system is operating, to

for each receive lane,

implement a training state machine including multiple training states;

transmit training frames to the second NIC and receive training frames from the second NIC;

detect frame lock has been acquired on training frames received by the receiver circuitry for the receive lane;

enter a TRAIN_LOCAL state;

while in the TRAIN_LOCAL state,

detect whether the frame lock is lost, and if so,

advance the training state to a FRAME_LOCK_RECOVER state;

while in the FRAME_LOCK_RECOVER state,

start a frame lock recover timer;

detect whether the frame lock recover timer has expired prior to re-acquiring frame lock, and if so,

advance the training state machine state to a TRAINING_FAILURE state.

22. The system of clause 21, wherein the first NIC is further configured to:

detect frame lock has been re-acquired prior to expiration of the frame lock recover timer; and

return the training state machine state to the TRAIN_LOCAL state.

23. The system of clause 21 or 22, wherein the first NIC is further configured to:

detect, while in the TRAIN_LOCAL state, a receiver trained condition, and in response thereto, advancing the training state machine state to a TRAIN_REMOTE state;

while in the TRAIN_REMOTE state,

detect whether frame lock on received training frames is lost or the receiver trained condition is lost, and if so,

advance the training state to the FRAME_LOCK_RECOVER state.

24. The system of any of clauses 21-23, wherein the first NIC is further configured to:

enter a SEND_TRAINING state;

while in the SEND_TRAINING state,

start a frame lock timer;

detect whether the frame lock timer has expired prior to acquiring a frame lock, and if so,

advance the training state machine state to the TRAINING_FAILURE state.

25. The system of any of clauses 21-24, wherein the first NIC is further configured to:

if frame lock is acquired prior to expiration of the frame lock timer,

advance the training state machine state to the TRAIN_LOCAL state.

26. The apparatus of any of clauses 21-25, wherein each training frame includes a coefficient update field, and the link training logic is further configured to prevent changes to the coefficient update field when frame lock is not acquired.

27. An apparatus configured to be implemented, when operating, as a first component that is linked in communication with a second component over a bi-directional link, comprising:

Physical Layer (PHY) circuitry, including,

a transmitter port including transmitter circuitry for at least one transmit lane;

a receiver port including receiver circuitry for at least one receive lane; and

link training logic;

a Media Access Control (MAC) module;

a Reconciliation Sublayer (RS) module; and

a Peripheral Component Interconnect Express (PCIe) interface;

wherein the link training logic in the PHY circuitry is configured to,

for each receive lane,

implement a training state machine including multiple training states;

transmit training frames to the second component and receive training frames from the second component;

detect frame lock has been acquired on training frames received by the receiver circuitry for the receive lane;

enter a TRAIN_LOCAL state;

while in the TRAIN_LOCAL state,

detect whether the frame lock is lost, and if so,

advance the training state to a FRAME_LOCK_RECOVER state;

while in the FRAME_LOCK_RECOVER state,

start a frame lock recover timer;

detect whether the frame lock recover timer has expired prior to re-acquiring frame lock, and if so,

advance the training state machine state to a TRAINING_FAILURE state.

28. The apparatus of clause 27, wherein the link training logic is further configured to:

detect frame lock has been re-acquired prior to expiration of the frame lock recover timer; and

return the training state machine state to the TRAIN_LOCAL state.

29. The apparatus of clause 27 or 28, wherein the link training logic is further configured to:

detect, while in the TRAIN_LOCAL state, a receiver trained condition, and in response thereto, advancing the training state machine state to a TRAIN_REMOTE state;

while in the TRAIN_REMOTE state,

detect whether frame lock on received training frames is lost or the receiver trained condition is lost, and if so,

advance the training state to the FRAME_LOCK_RECOVER state.

30. The apparatus of any of clauses 27-29, wherein the link training logic is further configured to:

enter a SEND_TRAINING state;

while in the SEND_TRAINING state,

start a frame lock timer;

detect whether the frame lock timer has expired prior to acquiring a frame lock, and if so,

advance the training state machine state to the TRAINING_FAILURE state.

31. The apparatus of clause 30, wherein the link training logic is further configured to:

if frame lock is acquired prior to expiration of the frame lock timer,

advance the training state machine state to the TRAIN_LOCAL state.

32. The apparatus of any of clauses 27-31, wherein the frame lock recover timer is configured to expire after 2 milliseconds.

33. The apparatus of any of clauses 27-32, wherein each training frame includes a coefficient update field, and the link training logic is further configured to prevent changes to the coefficient update field when frame lock is not acquired.

34. The apparatus of any of clauses 27-33, wherein the apparatus comprises an Ethernet network interface controller.

35. The apparatus of any of clauses 27-34, wherein the communication link comprises an InfiniBand link.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Italicized letters, such as ‘i’, ‘j’, ‘l’, ‘m’, ‘n’, ‘p’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a computer-readable or machine-readable non-transitory storage medium. A computer-readable or machine-readable non-transitory storage medium includes any mechanism for storing or transmitting information in a form readable by a machine (e.g., a computer). For example, a computer-readable or machine-readable non-transitory storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer-readable or machine-readable non-transitory storage medium may also include a storage or database from which content can be downloaded. The computer-readable or machine-readable non-transitory storage medium may also include a device or product having content stored thereon at a time of sale or delivery. Thus, delivering a device with stored content, or offering content for download over a communication medium may be understood as providing an article of manufacture comprising a computer-readable or machine-readable non-transitory storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including computer-readable or machine-readable non-transitory storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for training a bi-directional communications link between a pair of link partners at opposing ends of the communications link and including at least one lane, comprising:
for each lane,
implementing a training state machine including multiple training states;
transmitting training frames to a link partner and receiving training frames from the link partner;
detecting frame lock has been acquired;
entering a TRAIN_LOCAL state;
while in the TRAIN_LOCAL state,
detecting whether the frame lock is lost, and if so,
advancing the training state to a FRAME_LOCK_RECOVER state;
while in the FRAME_LOCK_RECOVER state,
starting a frame lock recover timer;
detecting whether the frame lock recover timer has expired prior to re-acquiring frame lock, and if so,
advancing the training state machine state to a TRAINING_FAILURE state.

2. The method of claim 1, further comprising:
detecting frame lock has been re-acquired prior to expiration of the frame lock recover timer; and
returning the training state machine state to the TRAIN_LOCAL state.

3. The method of claim 1, further comprising:
detecting, while in the TRAIN_LOCAL state, a receiver trained condition, and in response thereto, advancing the training state machine state to a TRAIN_REMOTE state;
while in the TRAIN_REMOTE state,
detecting whether frame lock on received training frames is lost or the receiver trained condition is lost, and if so,
advancing the training state to the FRAME_LOCK_RECOVER state.

4. The method of claim 1, further comprising:
entering a SEND_TRAINING state;
while in the SEND_TRAINING state,
starting a frame lock timer;
detecting whether the frame lock timer has expired prior to acquiring a frame lock on received training frames, and if so,
advancing the training state machine state to the TRAINING_FAILURE state.

5. The method of claim 4, further comprising:
if frame lock is acquired prior to expiration of the frame lock timer,
advancing the training state machine state to the TRAIN_LOCAL state.

6. The method of claim 4, wherein the frame lock timer is configured to expire after 50 milliseconds.

7. The method of claim 1, wherein the frame lock recover timer is configured to expire after 2 milliseconds.

8. The method of claim 1, wherein the communication links comprises an Ethernet link.

9. The method of claim 1, wherein the communication link comprises an InfiniBand link.

10. The method of claim 1, wherein each training frame includes a coefficient update field, the method further comprising preventing changes to the coefficient update field when frame lock is not acquired.

11. An apparatus configured to be implemented, when operating, in a first component that is linked in communication with a second component over a bi-directional link, comprising:
Physical Layer (PHY) circuitry, including,
a transmitter port including transmitter circuitry for at least one transmit lane;
a receiver port including receiver circuitry for at least one receive lane; and
link training logic, configured to,
for each receive lane,
implement a training state machine including multiple training states;
transmit training frames to the second component and receive training frames from the second component;
detect frame lock has been acquired on training frames received by the receiver circuitry for the receive lane;
enter a TRAIN_LOCAL state;
while in the TRAIN_LOCAL state,
detect whether the frame lock is lost, and if so,
advance the training state to a FRAME_LOCK_RECOVER state;
while in the FRAME_LOCK_RECOVER state,
start a frame lock recover timer;
detect whether the frame lock recover timer has expired prior to re-acquiring frame lock, and if so,
advance the training state machine state to a TRAINING_FAILURE state.

12. The apparatus of claim 11, wherein the link training logic is further configured to:
detect frame lock has been re-acquired prior to expiration of the frame lock recover timer; and
return the training state machine state to the TRAIN_LOCAL state.

13. The apparatus of claim 11, wherein the link training logic is further configured to:
detect, while in the TRAIN_LOCAL state, a receiver trained condition, and in response thereto, advancing the training state machine state to a TRAIN_REMOTE state;
while in the TRAIN_REMOTE state,
detect whether frame lock on received training frames is lost or the receiver trained condition is lost, and if so,
advance the training state to the FRAME_LOCK_RECOVER state.

14. The apparatus of claim 11, wherein the link training logic is further configured to:
enter a SEND_TRAINING state;
while in the SEND_TRAINING state,
start a frame lock timer;
detect whether the frame lock timer has expired prior to acquiring a frame lock, and if so,
advance the training state machine state to the TRAINING_FAILURE state.

15. The apparatus of claim 14, wherein the link training logic is further configured to:
if frame lock is acquired prior to expiration of the frame lock timer,
advance the training state machine state to the TRAIN_LOCAL state.

16. The apparatus of claim 14, wherein the frame lock timer is configured to expire after 50 milliseconds.

17. The apparatus of claim 11, wherein the frame lock recover timer is configured to expire after 2 milliseconds.

18. The apparatus of claim 11, wherein the communication links comprises an Ethernet link.

19. The apparatus of claim 11, wherein the communication link comprises an InfiniBand link.

20. The apparatus of claim 11, wherein each training frame includes a coefficient update field, and the link training logic is further configured to prevent changes to the coefficient update field when frame lock is not acquired.

21. A system comprising:
a chassis;
an inter-plane, mounted within the chassis, having first and second inter-plane connectors and wiring coupled therebetween configured to facilitate a multi-lane Ethernet link;
a first board having a first network interface controller (NIC) including Ethernet transmitter and receiver ports operatively coupled to a first board connector that is coupled to the first inter-plane connector;
a second board having a second NIC including Ethernet transmitter and receiver ports operatively coupled to a second board connector that is coupled to the second inter-plane connector,
wherein the Ethernet transmitter for each of the first and second NICs is configured to transmit data over multiple transmit lanes and the Ethernet receiver is configured to receive data over a receive lane, and the first NIC is configured, when the system is operating, to
for each receive lane,
implement a training state machine including multiple training states;
transmit training frames to the second NIC and receive training frames from the second NIC;
detect frame lock has been acquired on training frames received by the receiver circuitry for the receive lane;
enter a TRAIN_LOCAL state;
while in the TRAIN_LOCAL state,
detect whether the frame lock is lost, and if so,
advance the training state to a FRAME_LOCK_RECOVER state;
while in the FRAME_LOCK_RECOVER state,
start a frame lock recover timer;
detect whether the frame lock recover timer has expired prior to re-acquiring frame lock, and if so,
advance the training state machine state to a TRAINING_FAILURE state.

22. The system of claim 21, wherein the first NIC is further configured to:
detect frame lock has been re-acquired prior to expiration of the frame lock recover timer; and
return the training state machine state to the TRAIN_LOCAL state.

23. The system of claim 21, wherein the first NIC is further configured to:
detect, while in the TRAIN_LOCAL state, a receiver trained condition, and in response thereto, advancing the training state machine state to a TRAIN_REMOTE state;
while in the TRAIN_REMOTE state,
detect whether frame lock on received training frames is lost or the receiver trained condition is lost, and if so,
advance the training state to the FRAME_LOCK_RECOVER state.

24. The system of claim 21, wherein the first NIC is further configured to:
enter a SEND_TRAINING state;
while in the SEND_TRAINING state,
start a frame lock timer;
detect whether the frame lock timer has expired prior to acquiring a frame lock, and if so,
advance the training state machine state to the TRAINING_FAILURE state.

25. The system of claim 24, wherein the first NIC is further configured to:
if frame lock is acquired prior to expiration of the frame lock timer,
advance the training state machine state to the TRAIN_LOCAL state.
